(19) United States
(12) Patent Application Publication
(10) Pub. No.: US 2017/0048433 A1
(43) Pub. Date: Feb. 16, 2017

(54) Camera System For A Vehicle

(71) Applicants: Werner LANG, Ergersheim (DE); Sebastian HEGER, Markt Nordheim (DE); Peter GEISSENDOERFER, Gallmersgarten (DE); Jaap-Jan SNEL, Ergersheim (DE)

(72) Inventors: Werner LANG, Ergersheim (DE); Sebastian HEGER, Markt Nordheim (DE); Peter GEISSENDOERFER, Gallmersgarten (DE); Jaap-Jan SNEL, Ergersheim (DE)

(73) Assignee: MEKRA LANG GMBH & CO. KG

(21) Appl. No.: 15/235,805

(22) Filed: Aug. 12, 2016

(30) Foreign Application Priority Data
Aug. 14, 2015 (DE) 102015010648.1
Feb. 2, 2016 (EP) 16153855.8

(51) Int. Cl. H04N 5/225; G06K 9/00; B60R 1/00; H04N 5/33

(52) U.S. Cl. CPC H04N 5/2256; H04N 5/332; G06K 9/00791; B60R 1/00; B60R 2300/103; B60R 2300/8093

(57) ABSTRACT

A camera system for a vehicle having a capturing unit for acquiring image data of an object close to the vehicle, a processing unit for processing the acquired image data, a display unit for displaying the processed image data, and a illumination unit for illuminating the object. The illumination unit is adapted to emit infrared light by at least one IR light source. The illumination unit has at least one electric functional component, which is part of another functional unit of the vehicle, and/or wherein the illumination unit is adapted to emit light with a spectrum having a predetermined spectral range that is visible for the human eye.

### BACKGROUND OF THE INVENTION

1. Field of the Invention

The present invention relates to a camera system for a vehicle, which camera system may be used, for example, in a driver assistance system and mirror substitution system, respectively, for vehicles, e.g. commercial vehicles, and in particular to a camera system with additional IR (infrared) illumination.

2. Description of the Related Art

Conventional camera systems for a vehicle either use a camera-integrated IR illumination or an IR spotlight arranged separately from a camera. These known camera systems are, however, not optimally suitable for the use in a vehicle, due to deficiencies like, for example, back reflections of the illumination directly into the camera, or due to an insufficient or inhomogeneous illumination of the field of view.

### SUMMARY OF THE INVENTION

It is an object of the invention to provide a camera system with an additional, cost efficient IR illumination for a vehicle.

According to the invention, the above object is solved by a camera system for a vehicle, comprising a capturing unit for acquiring/capturing image data of an object in the vehicle environment, wherein the acquired image data is processed by a processing unit in order to be displayed on a display unit. To be able to capture the object in the vehicle environment by means of the capturing unit also in poor illumination conditions, the camera system according to the invention is provided with an illumination unit, wherein the illumination unit is adapted to emit infrared light by at least one IR light source, and wherein the illumination unit comprises at least one electric functional component, which is part of another functional unit of the vehicle, i.e. another functional unit associated with the vehicle.

According to the invention, this other functional unit of the vehicle may be, for example, an automotive lighting, e.g. a flashing light/turn-signal indicator, a side marker lamp, a headlight, a rear light, an ambient lamp, an entrance lamp, and/or a sensor like, for example, radar, ultra-sound, etc., and/or a radio reception device, e.g. a GPS antenna, toll antenna, CB radio antenna, radio antenna, etc., and/or an operating element for the vehicle like, for example, a handle/knob for a door opener, an operating unit for a loading flap, a crane etc.

Due to the fact that the IR light source is provided together with a functional unit of the vehicle, which usually already exists at the vehicle, no additional electric lines must be provided by integration into an existing electric functional unit. At the same time, existing vehicle connections (installation sites) may be used, thus saving further costs.

Additionally or alternatively, the illumination unit for the camera system according to the invention is adapted to emit light having a spectrum of a predetermined spectral range that is visible for the human eye.

According to the invention, the illumination unit is configured as a single light source, which emits light in the visible infrared range and in the predetermined spectral range. By using a single light source, the number of components to be used may be reduced. According to the invention, the visible infrared range, for example, at least partly comprises a red spectral portion, and the predetermined spectral range at least partly comprises a yellow spectral portion, so that, when mixing the same, the color orange is perceivable for the human eye, in particular orange according to ECE regulation 48 2.29.3, which came into force on 30 Jan. 2011.

According to a further development of the invention, the illumination unit may comprise at least one first light source and at least one second light source, wherein the at least one first light source is adapted to emit at least one first light beam in the infrared range that is visible for the human eye, and the at least one second light source is adapted to emit at least one second light beam in the predetermined spectral range that is visible for the human eye, wherein the at least one first light beam and the at least one second light beam overlap to create a mixed light beam that is perceivable by a human eye. In this way, for example by suitably choosing the predetermined spectral range (e.g. yellow), the illumination unit may be used as automotive lighting, which emits light in a desired spectral color, e.g. orange, as defined above.

According to a further embodiment of the invention the at least one first light beam and the at least one second light beam overlap such, that the mixed light beam comprises residual light of the at least one first light source and/or residual light of the at least one second light source. According to the invention, for example, the residual light having infrared portion of the at least one first light source is used by the capturing unit for capturing/acquiring the image data. This enables the capturing unit to produce good images of the object also in poor illumination conditions (e.g. at night).

According to a further development of the invention, the predetermined spectral range is, for example, yellow. Thus, by mixing the visible infrared light and the yellow light, a light color is defined, which is perceived as orange by the human eye. It is, thus, possible to use the illumination unit of the camera system according to the invention as a light source having red color spectrum (visible infrared range) at the side of a vehicle (e.g. as a side marker light), which is not allowed for conventional light sources having red color spectrum due to legal regulations for automotive lightings (ECE R48 installation of illumination and light-signalling devices, in particular item 5.15, side marker light; ECE R91 side marker lights, in particular item 8.1).

According to a further development of the invention, mixing of the at least one first light beam and the at least one second light beam is effected by at least one optical element for generating the mixed light beam. In this way, the overlapping range of the two light beams may be extended and suitably defined.

According to a further development of the invention, the optical element for mixing light beams is, for example, a diffusion plate, a diffusor, a collimator, a lens, a light conductor, or a combination thereof.

According to a further development of the invention, the at least one IR light source and the electric functional component, which is part of a functional unit of the vehicle, are spatially separated from the capturing unit so that it is ensured that no back reflections from the IR light source directly into the capturing unit occur.

According to another further development of the invention, the at least one IR light source and the electric functional component, which is part of a functional unit of the vehicle, are arranged spatially close to each other, e.g. on a common circuit board and/or in a common housing, so that costs are saved due to integration.

Alternatively, the IR light source may be arranged on a separate circuit board in a separate housing, and the at least one electric functional component may also be arranged on a separate circuit board in a separate housing, wherein both housings may be arranged in the camera system spatially separated from the capturing unit. Preferably, the housings may, nevertheless, be arranged on the vehicle in close proximity to each other, e.g. adjacent to each other.

The illumination unit comprising the IR light source and the electric functional component is preferably located close to the capturing unit, in order to ensure an optimum and homogenous illumination of the capturing unit's field of view with IR light.

According to a further development of the invention, the at least one IR light source and the functional component may have a common power supply, so that no additional electric power connection lines are required. In particular, the IR light source may, for example, use the electric power supply line of the functional unit of the vehicle, which functional unit comprises the electric functional component of the illumination unit.

IR illumination of camera systems is usually effected in a range of approximately 850-950 nm, which is not perceivable for the human eye, as the sensitivity of the human eye lies in a range of approximately 380 to 780 nm.

According to the invention, it is defined that the upper range of sensitivity of the human eye begins at 680 nm and ends at approximately 780 nm, wherein the range visible for a human eye lies between 380 nm and 780 nm.

According to a further development of the invention, the IR light source emits light above the wavelength range that is visible for the human eye, thus achieving an improved night vision ability of the camera system.

According to another further development of the invention, the IR light source emits light in the upper range of sensitivity of the human eye, also referred to as near-infrared light, which is still perceivable by the human eye.

According to the invention, additionally to the IR light source, the functional unit may emit light within the wavelength range that is visible for the human eye, or in the upper range of sensitivity of the human eye, thereby providing a light source having IR portion. Such light source having IR portion improves color rendering in good illumination conditions, when the IR light source is switched off, and, at the same time, ensures a good image in poor illumination conditions, when the IR light source is switched on.

According to a further development of the invention, the IR light source may change its state according to the driving situation and environmental parameters, respectively, i.e., may be switched on, for example, only in poor light conditions. Alternatively or additionally, the wave-length of the IR light emitted by the IR light source may be changed according to the driving situation. Further, also the illumination area illuminated by the IR light source may be changed according to the driving situation. For example, when turning, IR light may be switched on to improve visibility in an area laterally next to the vehicle, while said IR light is not switched on when driving straight ahead, where, for example, only one IR light source is provided for illuminating the area in front of the vehicle.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, an embodiment of the present invention is described with reference to the Figures.

FIG. 1 a schematic view of a camera system according to a first embodiment of the invention;

FIG. 2 a schematic view of a functional unit of a vehicle, which uses the camera system according to the first embodiment;

FIG. 3 a schematic view of a camera system according to a second embodiment of the invention;

FIG. 4 a schematic view of a camera system according to a third embodiment of the invention; and

FIG. 5 a schematic view of the illumination unit shown in FIG. 4.

### DETAILED DESCRIPTION OF THE PRESENTLY PREFERRED EMBODIMENTS

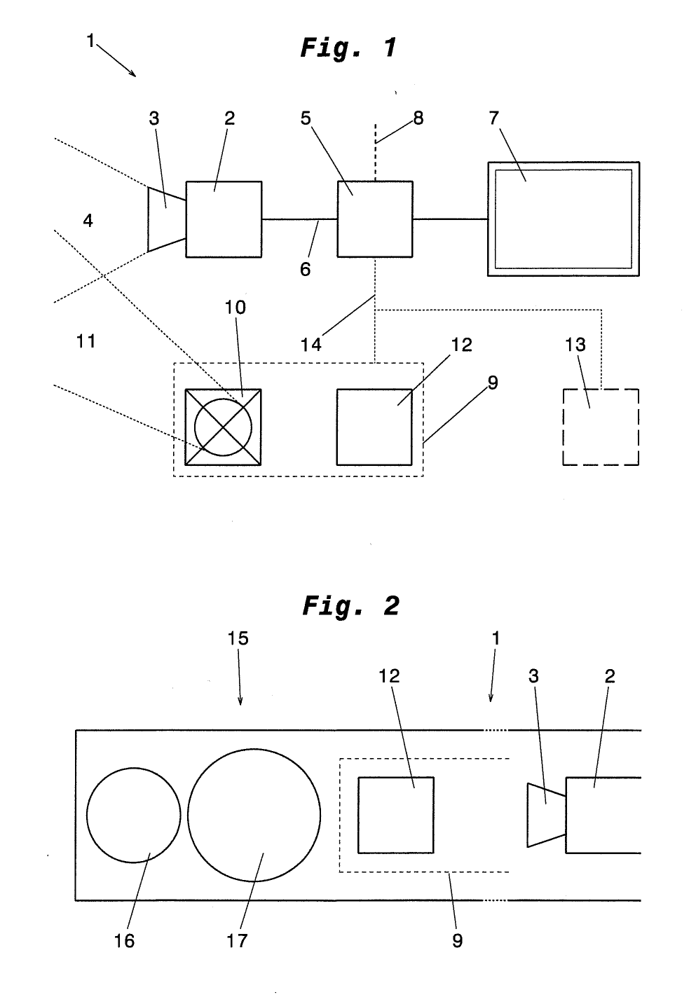

FIG. 1 shows a camera system 1 according to a first embodiment, which comprises a capturing unit 2. The capturing unit 2 is, for example, a camera having an objective 3 for acquiring/capturing image data of an object (not shown) located within a field of view 4 of the capturing unit 2.

According to the first embodiment, the capturing unit 2 is, e.g. wirelessly or wired, connected to a processing unit 5 via a connection 6. The processing unit 5 serves for further processing the image data acquired by the capturing unit 2, in order to output the same on a display unit 7.

According to the first embodiment, the display unit 7 is a monitor for visually displaying the image data of the object captured by the capturing unit. According to the preferred embodiment, the processing unit 5 is provided with further connections 8, via which connections, for example, data from a distance sensor (not shown) may be input into the processing unit 5.

As shown in FIG. 1, an illumination unit 9 is provided in the camera system 1 and located close to the capturing unit 2. The illumination unit 9 according to the first embodiment comprises an IR light source 10, whose IR light beam 11 at least partially overlaps the field of view 4 of the capturing unit 2.

As shown in FIG. 1, the illumination unit 9 further comprises an electric functional component 12, which is part of an already existing functional unit (not shown) of the vehicle. This already existing functional unit of the vehicle will be described in more detail below with reference to FIG. 2 and, according to the first embodiment, may be part of the automotive lighting like, for example, flashing light/turn-signal indicator, side marker light, headlight, rear light, ambient lamp, entry lamp, etc., a sensor like, for example, radar, ultrasound, etc., a device for radio reception like, for example, GPS antenna, toll antenna, CB radio antenna etc., and/or an operating element of the vehicle, e.g. an electric handle/knob for a door opener, an operating unit for a loading flap, a crane etc.

According to the first embodiment, the IR light source 10 and the electric functional component 12 of the illumination unit 9 are arranged spatially close to each other. Particularly, according to the first embodiment, the IR light source 10 and the electric functional component 12 are arranged in a common housing.

Alternatively, the IR light source 10 and the electric functional component 12 may be provided in separate housings.

According to the first embodiment, the IR light source 10 and the electric functional component 12 are formed on a common circuit board, wherein, alternatively, the IR light source 10 and the electric functional component 12 may be formed on separate circuit boards.

As shown in FIG. 1, the camera system 1 according to the first embodiment further comprises a control module 13 for driving the illumination unit 9. According to the first embodiment, this allows, for example, for changing the IR illumination by the IR light source 10 dependent on (according to) the driving situation. The IR light source 10 may, for example, be switched on and off dependent on (according to) the driving situation, and the wavelength of the IR light may be suitably adapted to the environmental conditions.

According to the first embodiment shown in FIG. 1, the control module 13 is further coupled to the processing unit 5; alternatively, however, it may be only coupled to the illumination unit 9 or the processing unit 5. Further connections between the control module 13 and any further components of the camera system 1 are also conceivable.

As mentioned above, the functional component 12 of the illumination unit 9 shown in FIG. 1 may also be part of a functional unit of the vehicle, which emits light within the wavelength range that is visible for the human eye, additionally or alternatively to the emission of IR light by the IR light source 10. Here, switching off and on the IR light source 10 and/or the functional unit may be effected by the control module 13.

FIG. 2 shows a schematic view of a camera system 1 according to FIG. 1 as part of a automotive lighting 15, which is a specific example for the above-mentioned functional unit of the vehicle according to the invention.

As shown in FIG. 2, the automotive lighting 15 comprises a flashing light/turn-signal indicator 16, a headlight 17, and the camera system 1 according to FIG. 1, which is only partially illustrated in FIG. 2.

As shown in FIG. 2, the functional component 12 of the camera system 1 is part of the automotive lighting 15 serving as functional unit according to the invention. According to a first embodiment, the functional component 12 of the camera system 1 is arranged on the circuit board of the automotive lighting 15 and uses the same power supply.

Further, according to the first embodiment of the invention, the functional component 12 is arranged in the housing of the automotive lighting 15; alternatively, however, it may also be arranged in a separate housing.

Further, according to the invention, the flashing light/turn-signal indicator 16 shown in FIG. 2 and/or the headlight 17 may respectively function as electric functional unit, so that the functional component 12 is part of the flashing light 16 and/or the headlight 17.

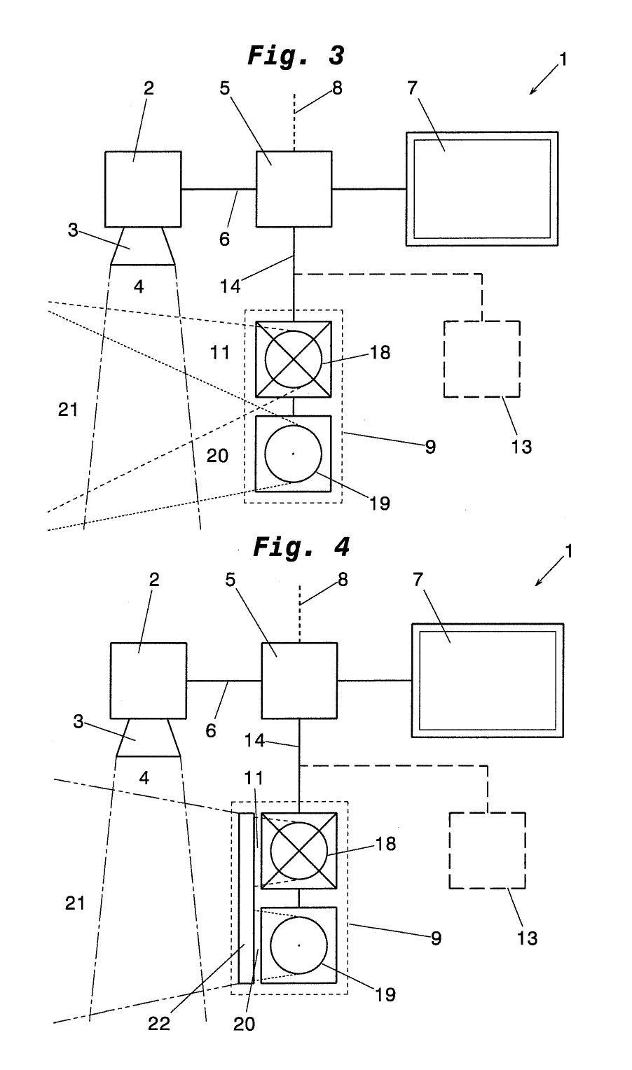

FIG. 3 shows a schematic illustration of the camera system 1 according to a second embodiment of the invention. The second embodiment of the invention differs from the above-described first embodiment of the invention in particular in that the illumination unit 9 comprises a first light source 18 and a second light source 19. According to the second embodiment, the first light source 18 emits light in the near-infrared range, i.e. infrared light, which is still perceivable by the human eye. In contrast, the second light source 19 emits light in a spectrum having a predetermined spectral range that is visible for the human eye. Preferably, the second light source 19 emits light having a yellow spectral portion.

As shown in FIG. 3, the first light source 18 covers an IR illumination range 11, and the second light source 19 covers an illumination range 20. According to this embodiment, the illumination range 20 illuminated by the second light source 19 is a yellow illumination range 20.

As can be further taken from FIG. 3, the IR illumination range 11 and the yellow illumination range 20 overlap to form a illumination range 21, which is perceived as orange by a human observer, due to the mixing of the colors red and yellow.

Dependent on the predetermined spectral range of the second light source 19, the color perceptible by a human may be correspondingly predefined in the illumination range 21.

The illumination unit 9 according to the second embodiment may, for example, be used as side marker/limitation light of a vehicle. Due to the color mixing of the infrared light of the first light source 18 and the yellow light of the second light source 19, a side marker/limitation light may be provided, which fulfils the legal provisions for automotive lightings.

Although the first light source 18 and the second light source 19 are shown in a common housing in FIG. 3, they may also be accommodated in separate housings. These separate housings are preferably close to each other, in order to generate an adequate common overlapping illumination range.

According to the invention, it is also possible that only a single light source is provided in the illumination unit 9, which functions as the first and second light source 18, 19 according to the second embodiment, i.e. is able to emit light having an infrared portion and a predetermined spectral range.

FIG. 4 shows a schematic illustration of a camera system according to a third embodiment of the invention.

The third embodiment of the invention differs from the second embodiment shown in FIG. 3 in that the illumination unit 9 additionally comprises an optical element 22. The optical element 22 is, for example, a diffusion plate, a diffusor, a collimator, a lens, a light conductor, etc. or a combination thereof.

The optical element 22 is, in particular, capable of mixing the infrared light emitted by the first light source 18 such with the yellow light emitted by the second light source 19 that the orange illumination range 21 is provided.

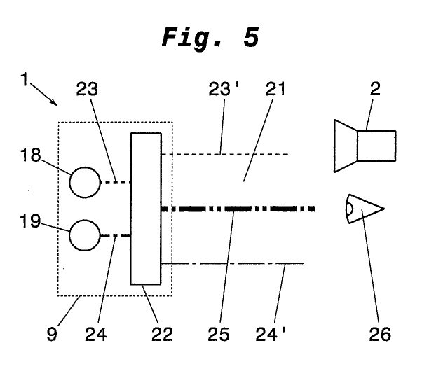

The optical element 22 according to the third embodiment reduces the illumination ranges 11 and 20 of the first light source 18 and the second light source 19, respectively, thereby extending the desired overlapping illumination range 21. In the following, the desired illumination range 21 according to FIG. 4 is explained below in more detail with reference to FIG. 5.

FIG. 5 shows a schematic illustration of the illumination unit 9 shown in FIG. 4.

As shown in FIG. 5, the optical element 22 mixes an infrared light beam 23 emitted by the first light source 18 with a yellow light beam 24 emitted by the second light source 19 such that a mixed light beam 25 is created, which is perceived as orange light by a human eye 26. As further shown in FIG. 5, the mixed light beam 25 comprises residual light 23′ from the first light source 18, as well as residual light 24′ from the second light source 19.

In particular the residual light 23′ from the first light source 18, which contains an IR portion, is used by the capturing unit 2 of the camera system according to the invention to allow for capturing a good image, e.g. under poor illumination conditions (at night).

Although in the above-described embodiments only one IR light source is illustrated in the illumination unit 9, it is obvious that also a plurality of IR light sources of this type may be provided in the illumination unit, together with a corresponding plurality of electric functional components, which are part of a plurality of corresponding, already existing, functional units of the vehicle.

Further, more than one capturing unit may be provided in the camera system according to the invention. Moreover, the above-mentioned components of the camera system may, for example, be accommodated in a common housing, or, if necessary, may be accommodated in separate housings, or arbitrarily combined in common housings.

Although, in the above, an automotive lighting has been described as specific example for an electric functional unit according to the invention, it is obvious that not only the above-described vehicle components may serve as electric functional unit, but also any other electric devices which already exist in the vehicle.

Further, although a first and second light source are shown in the above embodiments, the illumination unit may comprise a single light source having the functions of the first and second light source.

In the above, the yellow spectral range is mentioned as an example for the predetermined spectral range of the light emitted by the second light source 19. Depending on the desired color to be represented, any spectral range visible for the human eye may be provided.

Further, it is obvious that more than two light sources may be provided in the illumination unit 9, which respectively emit light having corresponding spectral ranges.

Further amendments and modifications of the above embodiment are possible without leaving the scope of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A camera system for a vehicle, comprising
a capturing unit for capturing image data of an object close to the vehicle;
a processing unit for processing the captured image data;
a display unit for displaying the processed image data; and
a illumination unit for illuminating the object, wherein
the illumination unit is adapted to emit infrared light from at least one IR light source, and wherein the illumination unit comprises at least one electric functional component, which is part of another functional unit of the vehicle, and/or
the illumination unit is adapted to emit light having a spectrum comprising a predetermined spectral range that is visible for the human eye.

2. The camera system according to claim 1, wherein the illumination unit is a single light source, which emits light in the infrared range and in the predetermined spectral range.

3. The camera system according to claim 1, wherein the illumination unit comprises at least one first light source and at least one second light source, the at least one first light source being adapted to emit at least one first light beam in the visible infrared range, and the at least one second light source being adapted to emit at least one second light beam in the predetermined spectral range, wherein the at least one first light beam and the at least one second light beam overlap to create a mixed light beam which is perceptible by the human eye.

4. The camera system according to claim 3, wherein overlapping of the at least one first light beam and the at least one second light beam is effected such that the mixed light beam comprises residual light of the at least one first light source and/or residual light of the at least one second light source.

5. The camera system according to claim 4, wherein the capturing unit uses the residual light having infrared portion of the at least one first light source for acquiring the image data.

6. The camera system according to claim 1, wherein the predetermined spectral range is yellow.

7. The camera system according to claim 1, wherein the illumination unit forms a side marker lamp of the vehicle.

8. The camera system according to claim 3, wherein mixing of the at least one first light beam and the at least one second light beam is effected by means of at least one optical element for creating the mixed light beam.

9. The camera system according to claim 8, wherein the optical element is a diffusion plate, a diffusor, a collimator, a lens and/or a light conductor.

10. The camera system according to claim 1, wherein
the at least one IR light source and the electric functional component are spatially separated from the capturing unit.

11. The camera system according to claim 1, wherein
the at least one IR light source and the electric functional component are spatially close to each other, and/or arranged in a common housing, and/or arranged on a common circuit board, and/or have a common power supply, and/or form a single component for providing a light source having IR portion.

12. The camera system according to claim 1, wherein
the at least one IR light source emits light above the wavelength range that is visible for the human eye.

13. The camera system according to claim 1, wherein
the at least one IR light source emits light in the upper range of the wavelength range that is visible for the human eye.

14. The camera system according to claim 1, wherein
the functional unit of the vehicle emits light in the wavelength range that is visible for the human eye.

15. The camera system according to claim 1, wherein
the functional unit is part of an automotive lighting, and/or comprises a sensor, and/or is a radio reception device, and/or is a control element for the vehicle.

16. The camera system according to claim 1, wherein
the illumination unit changes its state dependent on the driving situation and/or dependent on environmental parameters.
